(19) United States
(12) Patent Application Publication
(10) Pub. No.: US 2025/0246365 A1
(43) Pub. Date: Jul. 31, 2025

(54) HALF-TURN WINDING TRANSFORMER, CIRCUIT TOPOLOGY AND POWER DEVICE

(71) Applicant: SHANGHAI METAPWR ELECTRONICS CO., LTD, Shanghai (CN)

(72) Inventor: Yahong Xiong, Shanghai (CN)

(73) Assignee: SHANGHAI METAPWR ELECTRONICS CO., LTD, Shanghai (CN)

(21) Appl. No.: 19/035,853

(22) Filed: Jan. 24, 2025

(30) Foreign Application Priority Data
Jan. 31, 2024 (CN) 202410136938.X

(51) Int. Cl. H01F 30/06; H01F 27/00; H01F 27/245; H02M 7/00; H02M 7/217

(52) U.S. Cl. CPC H01F 30/06; H01F 27/006; H01F 27/245; H02M 7/003; H02M 7/217

(57) ABSTRACT

The application discloses a half-turn winding transformer, a circuit topology and a power device The half-turn winding transformer comprises a magnetic core, two high-voltage windings and four low-voltage windings; the magnetic core comprises two magnetic substrates and at least three magnetic columns, and the at least three magnetic columns are arranged in a row. According to the half-turn winding transformer, the step-down ratio between various input voltages and output voltages of the intermediate bus conversion device can be realized, and the application of different output voltage requirements is met; and on the other hand, by designing the winding mode and the device layout of the transformer, the loss of the transformer is reduced, and the size of the transformer is reduced.

### CROSS-REFERENCE TO RELATED APPLICATION

This application claims the priority benefit of China application serial no. 202410136938.X, filed on Jan. 31, 2024. The entirety of the above-mentioned patent application is hereby incorporated by reference herein and made a part of this specification.

### Description of Related Art

With the development of artificial intelligence, the power requirements of an artificial intelligence data processing chip, such as a CPU, a GPU, a TPU and the like (collectively, XPU) are higher and higher, so that the power of the server is increased, the power supply voltage of the server mainboard rises from 12V to 54V, and when the power supply voltage of the server mainboard is 54V, the two-stage step-down conversion circuit architecture gradually becomes mainstream.

The intermediate bus conversion (IBC) device in the two-stage step-down conversion circuit architecture is used for realizing voltage conversion between an input bus and an output bus, and the step-down ratio between the input voltage and the output voltage is 4:1, 8:1 or 12:1 and the like. With the diversification of application requirements, the demand for the output voltage of the intermediate bus conversion device is more and more. The application provides a circuit topology and a half-turn transformer. The low-voltage winding of the transformer is 0.5 turn, the high-voltage winding is (N−0.5) turn, and a transformer winding method and a part layout diagram are provided, so that the circuit topology not only can meet the requirements of various output voltages, but also obtains the advantages of low transformer loss and loss IBC's loss, high product efficiency and small size.

### SUMMARY

In view of the above, one of the objectives of the present application is to provide a half-turn winding transformer, comprising a magnetic core and windings, wherein the windings comprises a first high-voltage winding, a second high-voltage winding, a first low-voltage winding combination and a second low-voltage winding combination; the magnetic core comprises two magnetic substrates, two side columns and a middle column; the two side columns and one middle column are arranged between the two magnetic substrates, the two side columns and the middle column are arranged in a same direction, and the middle column is arranged between the two side columns; two channels between the two side columns and the middle column are a first channel and a second channel respectively;
the magnetic core comprises a first side surface, a second side surface, a third side surface and a fourth side surface, the first side surface and the third side surface are opposite, the second side surface and the fourth side surface are opposite, and the first channel and the second channel both penetrate through the second side surface and the fourth side surface;
each winding comprises a first end and a second end, and the first end and the second end of each of the first and second high-voltage windings are arranged close to a same side surface of the magnetic core; the second end of the first low-voltage winding combination and the first end of the second low-voltage winding combination are adjacent to the fourth side surface of the magnetic core, and the first end of the first low-voltage winding combination and the second end of the second low-voltage winding combination are adjacent to the second side surface of the magnetic core;
each of the first and second low-voltage winding combinations comprises two low-voltage windings, and two low-voltage windings in each of the first and second low-voltage winding combinations respectively penetrate through the first channel and the second channel; the first high-voltage winding sequentially penetrates through the second side surface, the second channel and the fourth side surface from the first end to the second end; and the second high-voltage winding sequentially penetrates through the fourth side surface, the first channel and the second side surface from the first end to the second end.

Preferably, wherein voltage waveforms at two ends of the two low-voltage windings penetrating through the same one of the first and second channels are staggered by 180 degrees; and the voltage waveforms at the two ends of the two low-voltage windings in the same one of the first and second low-voltage winding combinations are staggered by 180 degrees.

Preferably, wherein from the first end to the second end, the first high-voltage winding penetrates through the second side surface and then penetrates through the second channel, at least is wound around the middle column in one circle, and finally the first high-voltage winding penetrates through the fourth side surface; and from the first end to the second end, the second high-voltage winding penetrates through the fourth side surface and then penetrates through the first channel, at least is wound around the middle column in one circle, and finally the second high-voltage winding penetrates through the second side surface.

Preferably, wherein in the first channel, a direction of fundamental waves flowing through the second high-voltage winding and a direction of fundamental waves flowing through the first and second low-voltage windings are opposite, and magnitudes of the fundamental waves counteract; and in the second channel, a direction of a fundamental waves flowing through the first high-voltage winding and the direction of the fundamental waves flowing through the first and second low-voltage windings are opposite, and the magnitudes of the fundamental waves counteract.

A circuit topology, comprising an input positive terminal, an input negative terminal, an output positive terminal, an input capacitor, an output capacitor, a high-voltage side circuit and a low-voltage side circuit; the input capacitor is bridged between the input positive terminal and the input negative terminal, the high-voltage side circuit is bridged between the input positive terminal and the output positive terminal, and the low-voltage side circuit is bridged between the output positive terminal and the input negative terminal; and the low-voltage side circuit is a central tap rectifying circuit; the low-voltage side circuit comprises a first low-voltage winding combination and a first synchronous rectification switch combination; the first low-voltage winding combination comprises a first low-voltage winding and a second low-voltage winding; and the first synchronous rectification switch combination comprises a first synchronous rectification switch and a second synchronous rectification switch; the first low-voltage winding and the first synchronous rectification switch are connected in series between the output positive terminal and the input negative terminal, and the second low-voltage winding and the second synchronous rectification switch are connected in series between the output positive terminal and the input negative terminal; and the output capacitor is bridged between the output positive terminal and the input negative terminal.

Preferably, wherein the high-voltage side circuit comprises a switch bridge arm, a

capacitor bridge arm and a high-voltage side winding; the high-voltage side winding is bridged between a midpoint of the switch bridge arm and a midpoint of the capacitor bridge arm; the switch bridge arm comprises an upper switch and a lower switch, and the upper switch is electrically connected with the input positive terminal.

Preferably, wherein the circuit topology further comprises a first control signal and a second control signal; the first control signal and the second control signal are complementary; the upper switch and the first synchronous rectification switch are controlled by the first control signal to be turned on and turned off at a same time, and the lower switch and the second synchronous rectification switch are controlled by the second control signal to be turned on and turned off at a same time.

Preferably, wherein a first end of the high-voltage side winding is electrically connected with the switch bridge arm; second ends of the first low-voltage winding and the second low-voltage winding are electrically connected to the output positive terminal, and first ends of the first low-voltage winding and the second low-voltage winding are electrically connected with the corresponding synchronous rectification switch of the first and second synchronous rectification switches; and the first end of the high-voltage side winding, the second end of the first low-voltage windings and the first end of the second low-voltage windings are dotted ends.

A power device, comprises a first synchronous rectification switch combination, a second synchronous rectification switch combination and the half-turn winding transformer, the first synchronous rectification switch combination is arranged adjacent to the second side surface of the magnetic core, and the second synchronous rectification switch combination is arranged adjacent to the fourth side surface of the magnetic core.

Preferably, the power device further comprises an input positive terminal, an input negative terminal, an output positive terminal, an input capacitor, an output capacitor and a high-voltage side circuit; and the input capacitor is bridged between the input positive terminal and the input negative terminal; the high-voltage side circuit is bridged between the input positive terminal and the output positive terminal, each of the first and second low-voltage winding combinations comprises a first low-voltage winding and a second low-voltage winding, and each of the first and second synchronous rectification switch combinations comprises a first synchronous rectification switch and a second synchronous rectification switch; the first low-voltage winding and the first synchronous rectification switch are connected in series between the output positive terminal and the input negative terminal, and the second low-voltage winding and the second synchronous rectification switch are connected in series between the output positive terminal and the input negative terminal; and the output capacitor is bridged between the output positive terminal and the input negative terminal and is arranged adjacent to the second side surface and the fourth side surface of the magnetic core.

Preferably, wherein the high-voltage side circuit comprises a switch bridge arm, a capacitor bridge arm and a high-voltage side winding; the high-voltage side winding is bridged between a midpoint of the switch bridge arm and a midpoint of the capacitor bridge arm; the switch bridge arm comprises an upper switch and a lower switch, and the upper switch is electrically connected with the input positive terminal.

Preferably, wherein a first end of the high-voltage side winding is electrically connected with the switch bridge arm; second ends of the first low-voltage winding and the second low-voltage winding are electrically connected to the output positive terminal, and first ends of the first low-voltage winding and the second low-voltage winding are electrically connected with the corresponding synchronous rectification switch of the first and the second synchronous rectification switches; and the first end of the high-voltage side winding, the second end of the first low-voltage winding and the first end of the second low-voltage winding are dotted ends.

Compared with the prior art, the application has the following beneficial effects:
(1) According to the half-turn winding transformer, the step-down ratio between multiple input voltages and output voltages of the intermediate bus conversion device can be realized, and the application of different output voltage requirements is met.
(2) Through the winding mode and the device layout of the transformer, the loss of the transformer is reduced, and the size of the transformer is reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a topology of a half-bridge LLC circuit in the prior art;

FIG. 2A is a schematic diagram of a circuit topology 1A according to the present application;

FIG. 2B is a control timing diagram for each power switch of a circuit topology 1a;

FIG. 3A is a schematic diagram of a circuit topology 1b of the present application;

FIG. 3B is a winding mode of a low-voltage winding of a transformer of a circuit topology 1b;

FIG. 3C is a device layout of a low voltage circuit of a circuit topology 1b;

FIG. 3D is a winding mode of a half-turn high-voltage winding of a transformer of a circuit topology 1b; and

FIG. 3E and FIG. 3F are winding modes of a 1.5—turn high-voltage winding of the transformer of the circuit topology 1b.

### DESCRIPTION OF THE EMBODIMENTS

The technical solutions in the embodiments of the present disclosure will be clearly and completely described below with reference to the accompanying drawings in the embodiments of the present disclosure. All other embodiments obtained by a person of ordinary skill in the art based on the embodiments of the present application without creative efforts shall fall within the protection scope of the present application.

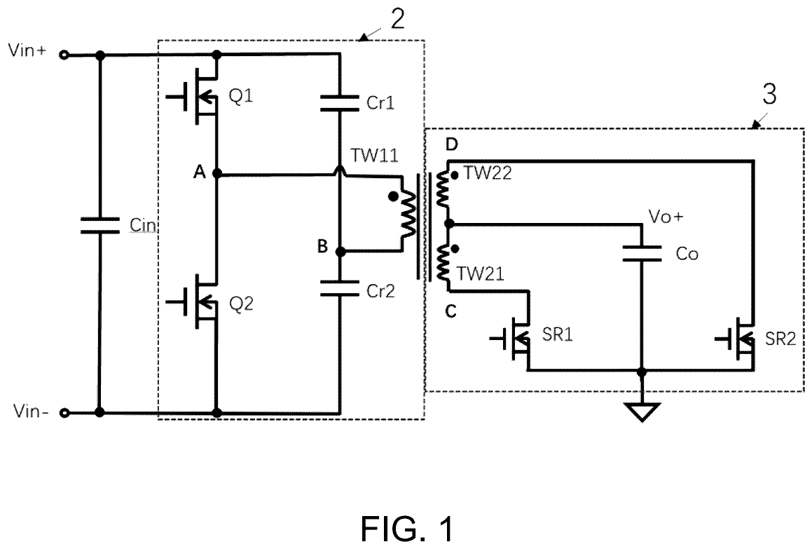

A traditional half-bridge LLC circuit schematic diagram as shown in FIG. 1 comprises a high-voltage side circuit 2, a low-voltage side circuit 3 and an input capacitor Cin, wherein the input capacitor Cin is bridged between the input positive terminal Vin+ and the input negative terminal Vin−; the power switch on the high-voltage side can realize zero-voltage turn-on, and the synchronous rectification switch on the low-voltage side can realize zero-current turn-on and turn-off. The half-bridge LLC circuit has the advantages of few power switch devices of primary side, simple circuit and small size. When the half-bridge LLC circuit is applied to the occasion of outputting large current, in order to reduce the winding loss of the transformer, the number of turns of the low-voltage side windings TW21 and TW22 of the transformer is generally 1 or 0.5. However, when the number of turns of the transformer low-voltage side windings TW21 and TW22 is 1 or 0.5, the step-down ratio of the input voltage Vin to the output voltage Vo of the circuit topology is always a multiple of 2 or a multiple of 4, and it is difficult to realize that the step-down ratio K of the input voltage to the output voltage is an odd number, so that the output voltage adaptive range of the circuit topology is limited, and the application scene of the circuit topology is limited.

Specifically, when the ratio of the number of turns of TW11 to TW21 and TW 22 is N:1:1, Vin=2N*Vo; when the ratio of the number of turns of TW11 to TW21 and TW 22 is N:0.5:0.5, Vin=4N*Vo, where N is a natural number.

According to the embodiment of the application, the step-down ratio K of the input voltage and the output voltage can be odd, so that the adaptive range of the output voltage Vo is wider, and the application scene of the proportional converter is widened.

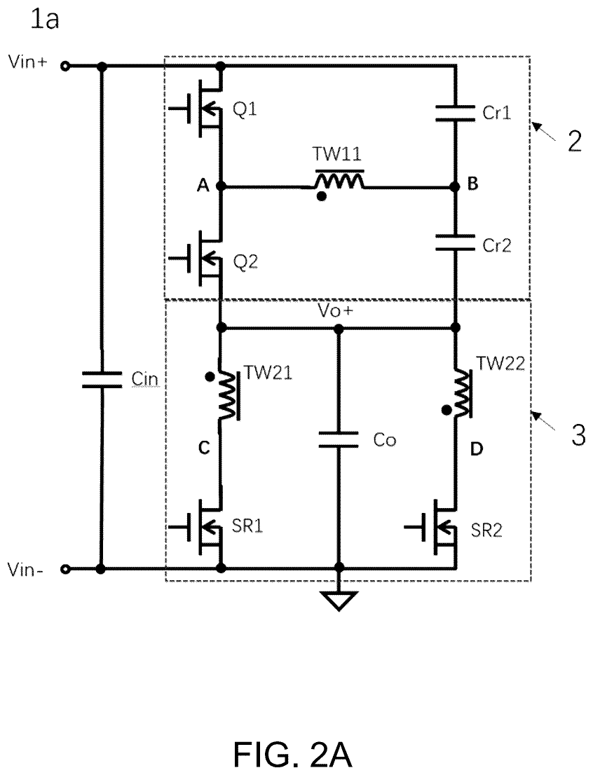

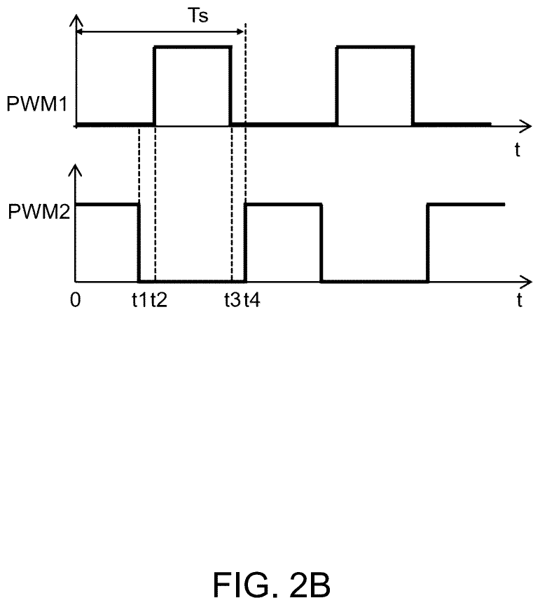

FIG. 2A is a schematic diagram of a circuit topology 1a disclosed in the present application. The circuit topology 1a comprises a high-voltage side circuit 2, a low-voltage side circuit 3, an input positive terminal Vin+, an input negative terminal Vin− and an output positive terminal Vo+. The high-voltage side circuit 2 comprises a switch bridge arm, a capacitor bridge arm and a high-voltage winding TW11; the switch bridge arm comprises half-bridge switches Q1 and Q2, and the source electrode of the half-bridge switch Q1 is in connected with the drain electrode of Q2 to form a connection point A; the capacitor bridge arm comprises half-bridge capacitors Cr1 and Cr2, and the Cr1 and the Cr2 are connected in series to form a connection point B. The input capacitor Cin is still bridged between the input positive terminal Vin+ and the input negative terminal Vin−; and the switch bridge arm and the capacitor bridge arm are connected in parallel and bridged between the input positive terminal Vin+ and the output positive terminal Vo+. The low-voltage side circuit 3 is a central tap rectification circuit and comprises synchronous rectification switches SR1 and SR2, and a second end of the low-voltage windings TW21 and TW22 and a second end of the output capacitor CO low-voltage winding TW21 and a second end of the TW 22 are short-connected to the output positive terminal Vo+; the first end of the low-voltage winding TW21 and the first end of the TW22 are electrically connected with the drain electrodes of the corresponding synchronous rectification switches SR1 and SR2 respectively; the sources of the synchronous rectification switches SR1 and SR2 are short-circuited, and the output capacitor Co is bridged between the output positive terminal Vo+ and the source electrodes of the synchronous rectification switches SR1 and SR2. The high-voltage winding TW11 is magnetically coupled with the low-voltage windings TW21 and TW22 to form a transformer, that is, the high-voltage winding TW11 of the transformer and the low-voltage windings TW21 and TW22 of the transformer are wound on the same magnetic core and are further wound on the same magnetic column of the same magnetic core; and the first end of the high-voltage winding TW11 (i.e., one end electrically connected to the connection point A), the second end of the low-voltage winding TW 21 (i.e., one end electrically connected to the output positive terminal Vo+) and the first end of the low-voltage winding TW22 (i.e., one end electrically connected to the drain of the synchronous rectification switch SR2) are mutually dotted terminals, and are labeled as point terminals.

In the circuit topology la, the leakage inductance of the transformer and the half-bridge capacitors Cr1 and Cr2 generate resonance; because the magnetizing inductance of the transformer is small, a large magnetization current can be generated to realize zero-voltage turn-on of the half-bridge switch Q1 or Q2.

As shown in FIG. 2B, the half-bridge switch Q1 and the synchronous rectification switch SR1 are controlled by a first pulse width control signal PWM1; and the half-bridge switch Q2 and the synchronous rectification switch SR2 are controlled by a second pulse width control signal PWM2. In a switching period Ts (i.e., interval 0˜t4) the interval t1˜t2 and the interval T3˜T4 are dead-times; in the interval 0˜t1, the half-bridge switch Q2 and the synchronous rectification switch SR2 are approximately simultaneously turn-on and turn-off at the same time; and in the interval t2˜t3, the half-bridge switch Q1 and the synchronous rectification switch SR1 are approximately simultaneously turn-on and turn-off at the same time. If the dead-times are ignored, the first pulse width control signal PWM1 and the second pulse width control signal PWM2 are complementary, and the duty ratio is close to 0.5.

When the number of turns of the low-voltage windings TW21 and TW22 is 1 turn, the turn ratio of the high-voltage winding TW11 and the low-voltage windings TW21 to TW22 is N:1:1, wherein N is a natural number. The input voltage Vin and the output voltage Vo satisfy a formula (1):

$$V i n = ( 2 N + 1 ) * V o \qquad ( 1 )$$

the step-down ratio K=2N+1 of the input voltage Vin and the output voltage Vo is 1, 2 and 3 respectively, and the corresponding step-down ratio K is 3, 5 and 7 respectively.

Therefore, through the circuit topology la and the control mode disclosed by the application, the step-down ratio K of the input voltage and the output voltage can be odd, so that the adaptive range of the output voltage Vo is wider, and the application scene of the proportional converter is widened.

In order to further reduce the conduction loss of the transformer, the number of turns of the low-voltage side winding of the transformer can be designed to be 0.5 turns, and the turn ratio of the high-voltage winding TW11 and the low-voltage winding TW21 to TW22 is N:0.5:0.5; and the input voltage Vin and the output voltage Vo meet the formula (2):

$$V i n = ( 4 N + 1 ) * V o \qquad ( 2 )$$

The step-down ratio K=4N+1 of the input voltage Vin and the output voltage Vo is 1, 2 and 3 respectively, the number of turns of the high-voltage winding TW11 is 1, 2 and 3 respectively, and the corresponding step-down ratio K is respectively 5, 9 and 13. In the application, although the high step-down ratio is realized, the adaptive range of the output voltage Vo is limited because the minimum step-down ratio is 5. On the basis, the high-voltage winding TW11 can also adopt a half-turn design, that is, the turn ratio of the high-voltage winding TW11 to the low-voltage winding TW21 to the TW22 is (N−0.5): 0.5:0.5, and N is a natural number. The input voltage Vin and the output voltage Vo satisfy a formula (3):

$$V i n = ( 4 N - 1 ) * V o \qquad ( 3 )$$

The step-down ratio K=4N−1 of the input voltage Vin and the output voltage Vo is 1, 2 and 3 respectively, the number of turns of the high-voltage winding TW11 is 0.5, 1.5 and 2.5 respectively, the corresponding step-down ratio K is 3, 7 and 11 respectively, and in the application, the step-down ratio K of the input voltage Vin to the output voltage Vo can be more suitable for selection.

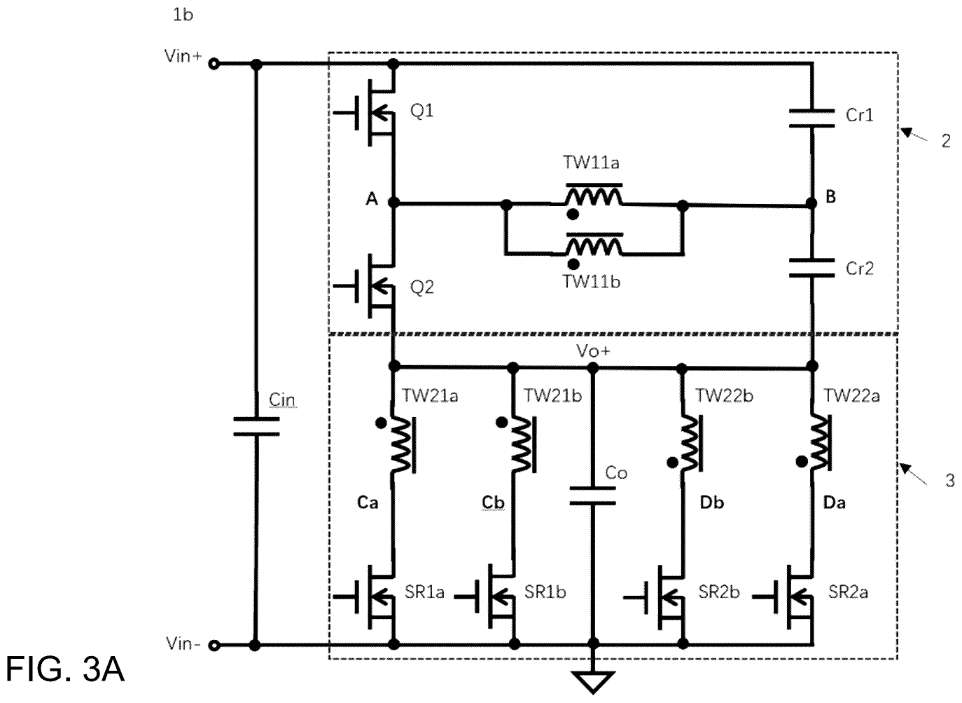

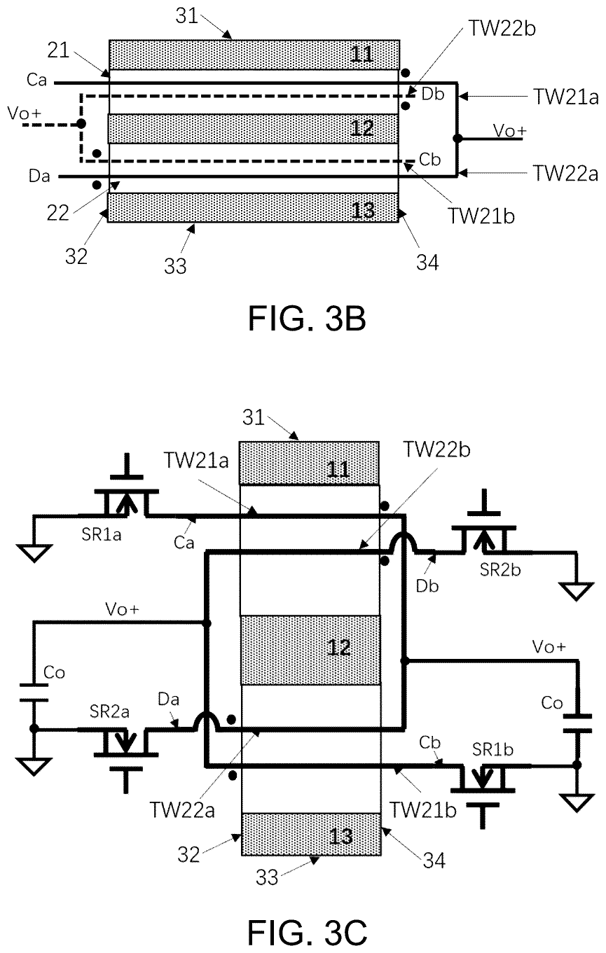

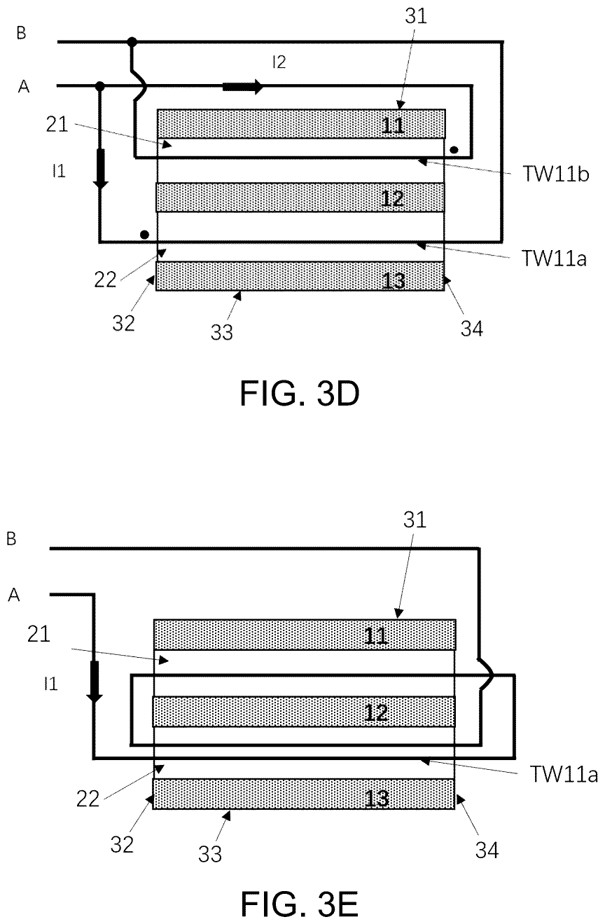

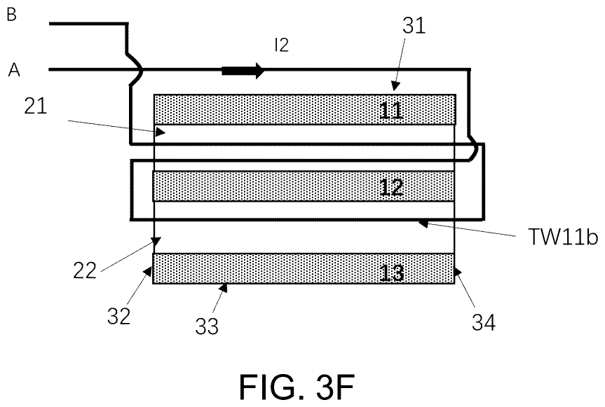

The application further discloses a structure of the transformer and a winding method of the winding, and the half-turn design of the high-voltage winding and the half-turn design of the low-voltage winding can be realized. The equivalent circuit schematic diagram is shown in FIG. 3A, and the difference between the circuit topology 1b and the circuit topology la lies in that the high-voltage winding comprises TW11a and TW11b, and the TW11a and TW11b are connected in parallel; the low-voltage winding comprises TW21a, TW21b, TW22a and TW22b, and the second end of each low-voltage winding is electrically connected with the output positive terminal Vo+. The first end of each low-voltage winding is electrically connected with the drain electrode of one synchronous rectification switch, and respectively corresponds to the drains of SR1a, SR1b, SR2a and SR2b. The first end of the low-voltage winding TW21a and a drain electrode of the synchronous rectification switch SR1a are electrically connected to the connection point Ca; the first end of the low-voltage winding TW21b and a drain electrode of the synchronous rectification switch SR1b are electrically connected to the connection point Cb; the first end of the low-voltage winding TW22a and a drain electrode of the synchronous rectification switch SR2a are electrically connected to the connection point Da; and the first end of the low-voltage winding TW22b and the drain electrode of the synchronous rectification switch SR2b are electrically connected to the connection point Db. That is, the low-voltage side circuit 3 comprises two center tap rectifying circuits which are connected in parallel. The high-voltage windings TW11a and TW11b are magnetically coupled with the low-voltage windings TW21a, TW21b, TW22a and TW22b to form a transformer; furthermore, the high-voltage windings TW11a and TW11b of the transformer and the low-voltage windings TW21a,

TW21b, TW22a and TW22b of the transformer are wound on the same magnetic core, and are further wound on the same magnetic column of the same magnetic core; and the first ends of the high-voltage windings TW11a and TW11b (i.e., one end electrically connected to the connection point A), the second ends of the low-voltage windings TW21a and TW21b (i.e., one end electrically connected to the output positive terminal Vo+), and the first ends of the low-voltage windings TW22a and TwW22b (i.e., the ends electrically connected to the synchronous rectification switch SR2a or SR2b respectively) are the dotted ends, and are marked as dots. As shown in FIG. 3B and FIG. 3C, the magnetic core includes a first side surface 31, a second side surface 32, a third side surface 33 and a fourth side surface 34, wherein the first side surface 31 and the third side surface 33 are opposite to each other, and the second side surface 32 and the fourth side surface 34 are opposite. The magnetic core further comprises two magnetic substrates (not shown in the figures), side columns 11 and 13 and a middle column 12, the side columns 11 and 13 and the middle column 12 are provided between the two magnetic substrates, and the side column 11, the middle column 12 and the side column 13 are sequentially arranged in the same direction. The channel between the side column 11 and the middle column 12 is a first channel 21, the channel between the side column 13 and the middle column 12 is a second channel 22. The first channel 21 and the second channel 22 both penetrate through the second side surface 32 and the fourth side surface 34. The high-voltage windings TW11a/TW11b and the low-voltage windings TW21a/TW21b/TW22a/TW22b can be arranged in the circuit board PCB, the high-voltage winding and the the low-voltage windings are respectively arranged on different wiring layers of the circuit board PCB, the magnetic core buckle the circuit board; but the winding mode disclosed by the application is not limited to the implementation mode. The circuit topology 1b can also adopt the control time sequence shown in FIG. 2B, wherein the half-bridge switch Q1 and the synchronous rectification switch SR1a and SR1b are controlled by a first pulse width control signal PWM1, and the half-bridge switch Q2 and the synchronous rectification switch SR2a and SR2b are controlled by a second pulse width control signal PWM2.

The winding mode of the low-voltage winding is shown in FIG. 3B, the low-voltage winding TW21a penetrates through the first channel 21, the first end (the connection point Ca) of the low-voltage winding TW21a is arranged close to the second side surface 32, and the second end (the output positive terminal Vo+) of the low-voltage winding TW21a is arranged close to the fourth side surface 34; the low-voltage winding TW22a passes through the second channel 22, a first end (the connection point Da) of the low-voltage winding TW22a is arranged adjacent to the second side surface 32, and a second end (the output positive terminal Vo+) of the low-voltage winding TW22a is arranged adjacent to the fourth side surface 34; the low-voltage winding TW21b passes through the second channel 22, a first end (the connection point Cb) of the low-voltage winding TW21b is arranged adjacent to the fourth side surface 34, and a second end (the output positive terminal Vo+) of the low-voltage winding TW21b is arranged adjacent to the second side surface 32; the low-voltage winding TW22b passes through the first channel 21, a first end (the connection point Db) of the low-voltage winding TW 22b is arranged adjacent to the fourth side surface 34, and a second end (the output positive terminal Vo+) of the low-voltage winding TW 22b is arranged adjacent to the second side surface 32.

FIG. 3C shows a device layout of the low-voltage side circuit 3. Synchronous rectifier switches SR1a and SR2a are disposed adjacent to a second side surface 32. The synchronous rectifier switch SR1a is bridged between the connection point Ca and the ground terminal (i.e., the input negative terminal Vin−). The synchronous rectifier switch SR2a is bridged between the connection point Da and the ground terminal (i.e., the input negative terminal Vin−); The synchronous rectification switch SR1b and the synchronous rectification switch SR2b are arranged adjacent to the fourth side surface 34, the synchronous rectification switch SR1b is bridged between the connection point Cb and the grounding terminal (the input negative terminal Vin−), and the synchronous rectification switch SR2b is bridged between the connection point Db and the grounding terminal. The output capacitor Co is disposed adjacent to the second side 32 and the fourth side 34, respectively, and is bridged between the output positive terminal Vo+ and the ground terminal.

As shown in FIG. 3C, the 0.5—turn structure and the winding mode of the low-voltage windings and the corresponding low-voltage circuit are arranged, so that the path of the low-voltage winding is short, the impedance of the low-voltage winding is low, and the loss generated on the low-voltage winding is reduced. The synchronous rectification switches are arranged on the two opposite sides of the magnetic core respectively, so that the space on the two opposite sides of the magnetic core can be more fully utilized, the number of the synchronous rectification switches is doubled, and the conduction loss of the power supply module is further reduced. Furthermore, the low-voltage winding TW21a and the low-voltage winding TW22a are respectively arranged in different channels. Comparing the current flowing through the low-voltage winding TW21a and the current flowing through the low-voltage winding TW22a, the amplitudes and directions of the direct-current currents of the low-voltage winding TW21a and the low-voltage winding TW22a are the same, the frequency and amplitude of the alternating current of the two are basically the same, and the phase-shift is 180 degrees. The low-voltage winding TW21b and the low-voltage winding TW22b are arranged in different channels respectively, comparing the current flowing through the low-voltage winding TW21b and the current flowing through the low-voltage winding TW22b, the amplitude and the direction of the direct current of the low-voltage winding TW21b and the low-voltage winding TW22b are the same, the frequency and amplitude of the alternating current of the two are basically the same, and the phase-shift is 180 degrees. The low-voltage windings TW21a and TW22b are arranged in the first channel 21. Comparing the current flowing through the low-voltage winding TW21a and the current flowing through the low-voltage winding TW22b, the direct current directions of the low-voltage winding TW21a and the low-voltage winding TW22b are opposite, the amplitudes are approximately the same, the currents of the two are superposed, and a approximately complete sine wave can be formed. The low-voltage windings TW21b and TW22a are arranged in the second channel 22. Comparing the current flowing through the low-voltage winding TW21b and the current flowing through the low-voltage winding TW22a are compared, the direct-current directions of the low-voltage winding TW21b and the low-voltage winding TW22a are opposite, the amplitudes are approximately the same, the currents of the two are superposed, and a approximately complete sine wave can be formed.

FIG. 3D shows a winding mode of high-voltage windings TW11a and TW11b with 0.5—turn. The first ends of the high-voltage windings TW11a and TW11b are both electrically connected to a midpoint (i.e., the connection point A) of the switch bridge arm, and the first ends are disposed adjacent to the second side surface 32; the high-voltage winding TW11a starts from the first end, passes through the second channel 22 and is wound along the fourth side surface 34 and the first side surface 31, and the second end is electrically connected with the midpoint (the connection point B) of the capacitor bridge arm; and the midpoint of the capacitor bridge arm is arranged adjacent to the first side surface 31 and the second side surface 32; and after the first end of the high-voltage winding TW11b passes through the first side surface 31 of the magnetic core, the first end of the high-voltage winding TW11b penetrates through the first channel 21 from the fourth side surface 34 of the magnetic core, and the second end is electrically connected with the midpoint (the connecting point B) of the capacitor bridge arm. The arrangement positions of the first end and the second end of the high-voltage winding are not limited herein, as long as the same side surface of the adjacent magnetic core can meet the requirements of the embodiment.

In the second channel 22, the fundamental current of the high-voltage winding TW11a has the same frequency and amplitude as compared to the fundamental current after the current superposition of the low-voltage windings TW21b and TW22a, and the directions are opposite; so that the fundamental wave current in the second channel 22 is close to offset; and due to the fact that the high-voltage winding TW11a, the low-voltage winding TW21b and the TW22a are overlapped in the circuit board, and the arrangement of different wiring layers meets the staggered relation, the alternating current resistance of the winding passing through the second channel 22 is small, and the winding loss is low. In the first channel 21, the direction of the fundamental current of the high-voltage winding TW11b is the same as the fundamental current after the low-voltage winding TW21a and the TW22b current are superposed, and the direction is opposite; so that the fundamental wave current in the first channel 21 is close to offset; and due to the fact that the high-voltage winding TW11b, the low-voltage windings TW21a and TW22b are overlapped in the circuit board, and the arrangement of different wiring layers meets the staggered relation, the alternating-current resistance of the winding penetrating through the first channel 21 is small, and the winding loss is low. Meanwhile, on the outer side of the magnetic core, namely the position adjacent to the first side surface 31, the current directions flowing through the high-voltage windings TW11a and TW11b are opposite, the current magnitude is approximately equal, the two high-voltage windings are overlapped in the circuit board, and the arrangement of the two high-voltage windings in different wiring layers meets the staggered relation, so that the alternating-current resistance of the winding group on the outer side part of the magnetic core is small, and the winding loss is low; and similarly, in a position adjacent to the second side surface 32 or a position adjacent to the fourth side surface 34, the current directions flowing through the high-voltage windings TW11a and TW11b are opposite, the currents are approximately equal in magnitude, the positions of the two high-voltage windings are overlapped in the circuit board, and the arrangement of the two high-voltage windings in different wiring layers meets an interleaving relationship.

According to the application, the high-voltage winding is divided into two branches TW11a and TW11b of the high-voltage winding, winding of 0.5 turns of the high-voltage winding is achieved, the turn ratio relationship between the high-voltage winding and the low-voltage winding of the transformer meets the requirement of output voltage, and the alternating-current resistance of the winding is reduced.

The winding mode of the half-turn high-voltage winding shown in FIG. 3D can also be expanded to 1.5 turns or 2.5 turns or even N+0.5 turns. As shown in FIG. 3E and FIG. 3F, FIG. 3E shows a winding mode that the high-voltage winding TW11a is 1.5 turns, and FIG. 3F shows a winding mode that the high-voltage winding TW11b is 1.5 turns.

From the first end to the second end, the high-voltage winding TW11a passes through the second channel 22, passes through the second channel 22 from the second side surface 32, then winds around the middle column 12 counterclockwise in a circle, passes out from the fourth side surface 34, and is electrically connected with the midpoint (i.e., the connection point B) of the capacitor bridge arm along the fourth side surface 34 and the first side surface 31. From the first end to the second end, the high-voltage winding TW11b penetrates through the first channel 21 from the fourth side surface 34 after passing through the first side surface 31 and then winds around the middle column 12 counterclockwise in a circle, passes through the second side surface 32, and the other end is electrically connected with the midpoint (namely the connection point B) of the capacitor bridge arm. According to the embodiment, multiple step-down ratios of the input voltage to the output voltage can be realized, so that the circuit topology 1b meets more output voltage requirements.

In addition, parallel connection of the high-voltage winding and parallel connection of the low-voltage winding are realized in the same magnetic core, so that the load capacity of the power conversion device adopting the circuit topology is expanded, the size of the magnetic core is reduced, and the high power density of the power conversion device is realized.

The switch tube disclosed by the application can be used for realizing the functions of the switch disclosed by the application, such as a Si MOSFET, SiC MOSFET, GaN MOSFET or IGBT MOSFET.

The power conversion device according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A half-turn winding transformer, comprising a magnetic core and windings, wherein the windings comprises a first high-voltage winding, a second high-voltage winding, a first low-voltage winding combination and a second low-voltage winding combination; the magnetic core comprises two magnetic substrates, two side columns and a middle column; the two side columns and one middle column are arranged between the two magnetic substrates, the two side columns and the middle column are arranged in a same direction, and the middle column is arranged between the two side columns; two channels between the two side columns and the middle column are a first channel and a second channel respectively;
the magnetic core comprises a first side surface, a second side surface, a third side surface and a fourth side surface, the first side surface and the third side surface are opposite, the second side surface and the fourth side surface are opposite, and the first channel and the second channel both penetrate through the second side surface and the fourth side surface;
each winding comprises a first end and a second end, and the first end and the second end of each of the first and second high-voltage windings are arranged close to a same side surface of the magnetic core; the second end of the first low-voltage winding combination and the first end of the second low-voltage winding combination are adjacent to the fourth side surface of the magnetic core, and the first end of the first low-voltage winding combination and the second end of the second low-voltage winding combination are adjacent to the second side surface of the magnetic core;
each of the first and second low-voltage winding combinations comprises two low-voltage windings, and two low-voltage windings in each of the first and second low-voltage winding combinations respectively penetrate through the first channel and the second channel; the first high-voltage winding sequentially penetrates through the second side surface, the second channel and the fourth side surface from the first end to the second end; and the second high-voltage winding sequentially penetrates through the fourth side surface, the first channel and the second side surface from the first end to the second end.

2. The half-turn winding transformer of claim 1, wherein voltage waveforms at two ends of the two low-voltage windings penetrating through the same one of the first and second channels are staggered by 180 degrees; and the voltage waveforms at the two ends of the two low-voltage windings in the same one of the first and second low-voltage winding combinations are staggered by 180 degrees.

3. The half-turn winding transformer of claim 1, wherein from the first end to the second end, the first high-voltage winding penetrates through the second side surface and then penetrates through the second channel, at least is wound around the middle column in one circle, and finally the first high-voltage winding penetrates through the fourth side surface; and from the first end to the second end, the second high-voltage winding penetrates through the fourth side surface and then penetrates through the first channel, at least is wound around the middle column in one circle, and finally the second high-voltage winding penetrates through the second side surface.

4. The half-turn winding transformer of claim 1, wherein in the first channel, a direction of fundamental waves flowing through the second high-voltage winding and a direction of fundamental waves flowing through the first and second low-voltage windings are opposite, and magnitudes of the fundamental waves counteract; and in the second channel, a direction of a fundamental waves flowing through the first high-voltage winding and the direction of the fundamental waves flowing through the first and second low-voltage windings are opposite, and the magnitudes of the fundamental waves counteract.

5. A circuit topology, comprising an input positive terminal, an input negative terminal, an output positive terminal, an input capacitor, an output capacitor, a high-voltage side circuit and a low-voltage side circuit; the input capacitor is bridged between the input positive terminal and the input negative terminal, the high-voltage side circuit is bridged between the input positive terminal and the output positive terminal, and the low-voltage side circuit is bridged between the output positive terminal and the input negative terminal; and the low-voltage side circuit is a central tap rectifying circuit; the low-voltage side circuit comprises a first low-voltage winding combination and a first synchronous rectification switch combination; the first low-voltage winding combination comprises a first low-voltage winding and a second low-voltage winding; and the first synchronous rectification switch combination comprises a first synchronous rectification switch and a second synchronous rectification switch; the first low-voltage winding and the first synchronous rectification switch are connected in series between the output positive terminal and the input negative terminal, and the second low-voltage winding and the second synchronous rectification switch are connected in series between the output positive terminal and the input negative terminal; and the output capacitor is bridged between the output positive terminal and the input negative terminal.

6. The circuit topology of claim 5, wherein the high-voltage side circuit comprises a switch bridge arm, a capacitor bridge arm and a high-voltage side winding; the high-voltage side winding is bridged between a midpoint of the switch bridge arm and a midpoint of the capacitor bridge arm; the switch bridge arm comprises an upper switch and a lower switch, and the upper switch is electrically connected with the input positive terminal.

7. The circuit topology of claim 6, wherein the circuit topology further comprises a first control signal and a second control signal; the first control signal and the second control signal are complementary; the upper switch and the first synchronous rectification switch are controlled by the first control signal to be turned on and turned off at a same time, and the lower switch and the second synchronous rectification switch are controlled by the second control signal to be turned on and turned off at a same time.

8. The circuit topology of claim 6, wherein a first end of the high-voltage side winding is electrically connected with the switch bridge arm; second ends of the first low-voltage winding and the second low-voltage winding are electrically connected to the output positive terminal, and first ends of the first low-voltage winding and the second low-voltage winding are electrically connected with the corresponding synchronous rectification switch of the first and second synchronous rectification switches; and the first end of the high-voltage side winding, the second end of the first low-voltage windings and the first end of the second low-voltage windings are dotted ends.

9. A power device, comprising a first synchronous rectification switch combination, a second synchronous rectification switch combination and the half-turn winding transformer according to claim 1, the first synchronous rectification switch combination is arranged adjacent to the second side surface of the magnetic core, and the second synchronous rectification switch combination is arranged adjacent to the fourth side surface of the magnetic core.

10. The power device of claim 9, further comprises an input positive terminal, an input negative terminal, an output positive terminal, an input capacitor, an output capacitor and a high-voltage side circuit; and the input capacitor is bridged between the input positive terminal and the input negative terminal; the high-voltage side circuit is bridged between the input positive terminal and the output positive terminal, each of the first and second low-voltage winding combinations comprises a first low-voltage winding and a second low-voltage winding, and each of the first and second synchronous rectification switch combinations comprises a first synchronous rectification switch and a second synchronous rectification switch; the first low-voltage winding and the first synchronous rectification switch are connected in series between the output positive terminal and the input negative terminal, and the second low-voltage winding and the second synchronous rectification switch are connected in series between the output positive terminal and the input negative terminal; and the output capacitor is bridged between the output positive terminal and the input negative terminal and is arranged adjacent to the second side surface and the fourth side surface of the magnetic core.

11. The power device of claim 10, wherein the high-voltage side circuit comprises a switch bridge arm, a capacitor bridge arm and a high-voltage side winding; the high-voltage side winding is bridged between a midpoint of the switch bridge arm and a midpoint of the capacitor bridge arm;
the switch bridge arm comprises an upper switch and a lower switch, and the upper switch is electrically connected with the input positive terminal.

12. The power device of claim 11, wherein a first end of the high-voltage side winding is electrically connected with the switch bridge arm; second ends of the first low-voltage winding and the second low-voltage winding are electrically connected to the output positive terminal, and first ends of the first low-voltage winding and the second low-voltage winding are electrically connected with the corresponding synchronous rectification switch of the first and the second synchronous rectification switches; and the first end of the high-voltage side winding, the second end of the first low-voltage winding and the first end of the second low-voltage winding are dotted ends.
